(19) United States
(12) Patent Application Publication
(10) Pub. No.: US 2021/0323110 A1
(43) Pub. Date: Oct. 21, 2021

(54) SYSTEMS AND METHODS FOR POLISHING A CYLINDRICAL LIP-SEAL SURFACE

(71) Applicant: Amsted Rail Company, Inc., Chicago, IL (US)

(72) Inventor: Anna Kathryn Brown, Richmond, VA (US)

(21) Appl. No.: 17/233,146

(22) Filed: Apr. 16, 2021

Related U.S. Application Data
(60) Provisional application No. 63/011,781, filed on Apr. 17, 2020.

(51) Int. Cl. B24B 5/04; B24B 5/35; F16J 15/3204; B29D 99/00

(52) U.S. Cl. CPC B24B 5/04; B29D 99/0053; F16J 15/3204; B24B 5/35

(57) ABSTRACT

A system for polishing a cylindrical lip-seal surface includes a spin platter, a polisher having an abrasive surface, and a fixture. The spin platter rotates about a rotation axis to spin a workpiece, shaped as a hollow cylinder, about a cylinder axis of the hollow cylinder. The fixture holds the polisher against an outward-facing cylindrical surface of the hollow cylinder to polish the cylindrical surface with the abrasive surface while the workpiece is spun by the spin platter. A method for polishing a cylindrical lip-seal surface includes spinning, with a spin platter, a workpiece shaped as a hollow cylinder about a first cylinder axis of the cylinder. The method also includes holding, during the spinning, a polisher having an abrasive surface against an outward-facing cylindrical surface of the hollow cylinder to polish the cylindrical surface.

### CROSS-REFERENCE TO RELATED APPLICATIONS

This application claims priority to U.S. Provisional Patent Application No. 63/011,781, filed Apr. 17, 2020 and titled “Systems and Methods for Polishing Cylindrical Lip-Seal Surface”, the entirety of which is incorporated herein by reference.

### BACKGROUND

Wheel bearings generally require a bearing seal that seals between the bearing and the external environment, to prevent contaminants from entering the bearing and to prevent or at least reduce loss of oil from the bearing. A part of the bearing seal is affixed to the rotating part of the wheel assembly (the hub), and another part of the bearing seal is affixed to the stationary part of the wheel assembly (the axle). Many seals form a labyrinth between the rotating and stationary seal parts to create an arduous leakage path between bearing and the external environment while minimizing friction between the rotating and stationary seal parts. Some seals are so called non-contact seals where the rotating part of the seal does not contact the stationary part of the seal. Contact seals are more common though. In a typical contact seal, also referred to as a lip seal, one or more elastomers form a bridge between the rotating part of the seal and the non-rotating part of the seal to provide a physical barrier.

### SUMMARY

The present embodiments include systems and methods for polishing a cylindrical lip-seal surface to be used in a contact-type bearing seal. A polished lip-seal surface, as provided by the present embodiments, may improve the longevity of the contact seal and thus reduce maintenance requirements and/or improve the longevity of the bearing itself. The presently disclosed methods for polishing the lip-seal surface are well-suited for integration with other processing steps to produce the part forming the lip-seal surface.

In an embodiment, a system for polishing a cylindrical lip-seal surface includes a spin platter, a polisher, and a fixture. The spin platter is configured to rotate about a rotation axis to spin a workpiece, shaped as a hollow cylinder, about a cylinder axis of the hollow cylinder. The hollow cylinder has a cylindrical surface facing away from the cylinder axis. The polisher includes an abrasive surface. The fixture is configured to hold the polisher against the cylindrical surface to polish the cylindrical surface with the abrasive surface while the workpiece is spun by the spin platter.

In an embodiment, a method for polishing a cylindrical lip-seal surface includes spinning, with a spin platter, a workpiece shaped as a hollow cylinder about a first cylinder axis of the hollow cylinder. The hollow cylinder has a cylindrical surface facing away from the first cylinder axis. The method also includes holding, during said spinning, a polisher having an abrasive surface against the cylindrical surface to polish the cylindrical surface.

### BRIEF DESCRIPTION OF THE DRAWINGS

FIGS. 1A and 1B illustrate an example assembly that may benefit from implementing a cylindrical lip-seal surface polished according to the present embodiments.

FIG. 2 is a flowchart for a method for manufacturing a sleeve with a polished lip-seal surface, according to an embodiment.

FIG. 3 is a set of diagrams illustrating one example of the method of FIG. 2.

FIG. 4 illustrates a system for polishing a cylindrical lip-seal surface of a workpiece, according to an embodiment.

FIG. 5 shows the workpiece of FIG. 4 in further detail.

FIG. 6 shows another workpiece that may be polished by the system of FIG. 4.

FIG. 7 illustrates a cylindrical polishing wheel, according to an embodiment.

FIG. 8 illustrates a system, for polishing a cylindrical lip-seal surface of a workpiece, which implements a fixture with at least one ball-transfer unit configured to help secure the workpiece on a spin platter, according to an embodiment.

FIG. 9 illustrates a system, for polishing a cylindrical lip-seal surface of a workpiece, which implements a fixture with two ball-transfer units configured to help secure the workpiece on a spin platter, according to an embodiment.

FIGS. 10A-C illustrate a system for polishing a cylindrical lip-seal surface of a workpiece, wherein a polisher is mounted on a translatable swing arm configured to swing out of the way to provide access to a spin platter, according to an embodiment.

FIG. 11 illustrates a method for polishing a cylindrical lip-seal surface, according to an embodiment.

FIGS. 12A-D illustrate, in perspective view, a system for polishing a cylindrical lip-seal surface of a workpiece, according to an embodiment.

FIG. 13 illustrates a polisher having non-uniform surface roughness, according to an embodiment.

FIG. 14 illustrates a convex polisher, according to an embodiment.

FIG. 15 illustrates a concave polisher, according to an embodiment.

FIG. 16 illustrates a stepped-diameter polisher, according to an embodiment.

### DETAILED DESCRIPTION

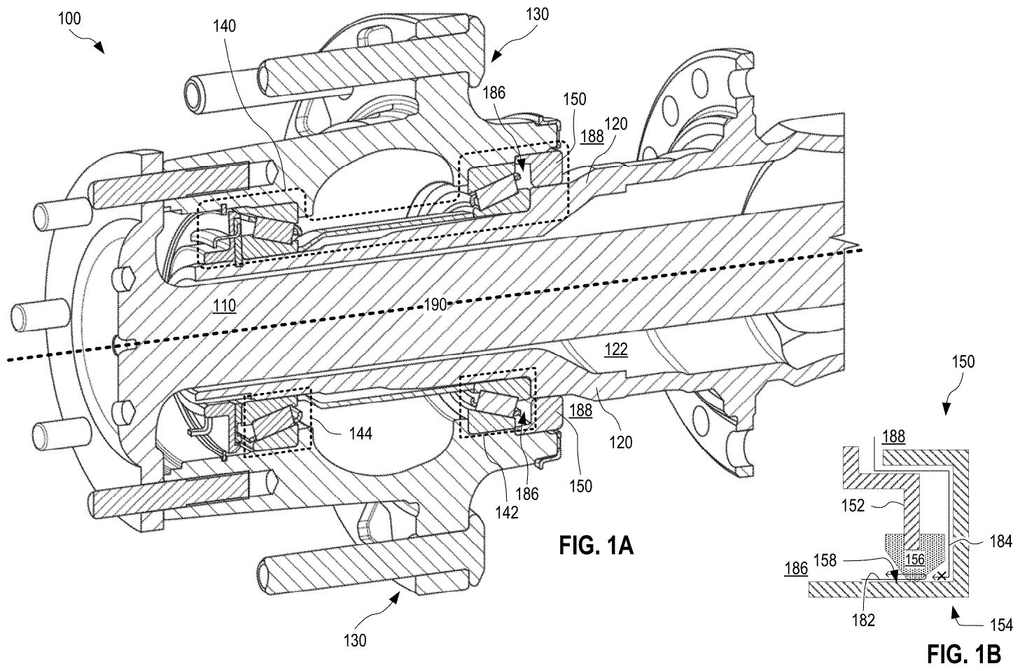

FIGS. 1A and 1B depict one example assembly, namely a drive wheel end 100 of a vehicle, which may benefit from implementing a cylindrical lip-seal surface polished according to the present invention. FIG. 1A is an isometric full-section view showing one half of drive wheel end 100. The section used in FIG. 1A contains the rotation axis 190 of drive wheel end 100. FIG. 1B is a schematic view of certain features of a bearing seal 150 of drive wheel end 100, depicted in a cross-sectional view with the cross section being in a plane that contains rotation axis 190. FIGS. 1A and 1B are best viewed together in the following description.

Drive wheel end 100 includes an axle shaft 110, and axle 120, a hub assembly 130, and a bearing system 140. Axle shaft 110 passes through the interior 122 of axle 120, and is rigidly attached to hub assembly 130 outside axle 120. Hub assembly 130 is configured to accommodate a wheel (not shown in FIG. 1A). Axle 120 supports at least part of the load of the vehicle. To engage drive wheel end 100, an engine rotates axle shaft 110 via a drive line, which causes hub assembly 130 to rotate about axle 120. Bearing system 140 reduces friction between hub assembly 130 and axle 120. For this purpose, bearing system 140 includes one or more bearings, for example an inboard bearing 142 and an outboard bearing 144, as depicted in FIG. 1.

Bearing system 140 also includes bearing seal 150. Bearing seal 150 seals between (a) an “oil side” 186 of bearing seal 150, on which bearings 142 and 144 are located, and (b) an “air side” 188 of bearing seal 150 associated with the external environment of drive wheel end 100. Bearing seal 150 has two functions. One function is prevention or reduction of transport of contaminants from air side 188 to oil side 186, so as to protect bearings 142 and 144 from increased friction and/or damage induced by contamination. Another function is prevention or reduction of loss of oil, grease, or other lubricant from bearing system 140 to air side 188.

Bearing seal 150 is of the contact-type and includes a seal case 152 and a sleeve 154. Seal case 152 is coupled to hub assembly 130, and sleeve 154 is coupled to axle 120. Seal case 152 and sleeve 154 are typically made of a metal, such as steel, and are not in direct contact with each other. To close the gap between seal case 152 and sleeve 154, while minimizing friction therebetween, bearing seal 150 further includes a lip 156 that is made of a softer material and closes the gap between seal case 152 and sleeve 154. Lip 156 is, for example, made of an elastomer. In the example shown in FIG. 1B, lip 156 is affixed to seal case 152 and bridges across the gap to sleeve 154. When hub assembly 130 rotates about axle 120, lip 156 rotates about sleeve 154 while maintaining contact with a lip-seal surface 158 of sleeve 154. Lip 156 thereby prevents, or at least reduces, transport of contaminants from air side 188 to oil side 186 (see arrow 184). Lip 156 further prevents, or at least reduces, leakage of lubricant from oil side 186 to air side 188. Lip 156 may be shaped to continuously pump back lubricant escaping from oil side 186, as indicated by arrow 182.

The longevity of lip 156 may be improved by polishing lip-seal surface 158, as a polished lip-seal surface reduces wear of the material of lip 156. In addition, the effectiveness of the seal provided by lip 156 may be improved by polishing of lip-seal surface 158 as such polishing may remove or reduce striations on the lip-seal surface.

Bearing seal 150 is just one example of bearing seals relying on a lip to continuously press against and rotate relative to a lip-seal surface. Most contact-type bearing seals utilize such a lip, and these contact seals, or lip seals, are found in many different applications, not limited to drive wheel ends. Drive wheel end 100 is only one of many types of systems that may implement a cylindrical lip-seal surface polished according to the present invention. Other types of systems that may benefit from such a polished cylindrical lip-seal surface include non-drive wheel ends equipped with a contact bearing-seal. More generally, such polished cylindrical lip-seal surfaces may be implemented in ball bearing assemblies and roller bearing assemblies equipped with a contact seal. In such assemblies, a polished lip-seal surface provided by the present invention may improve the longevity of the contact seal.

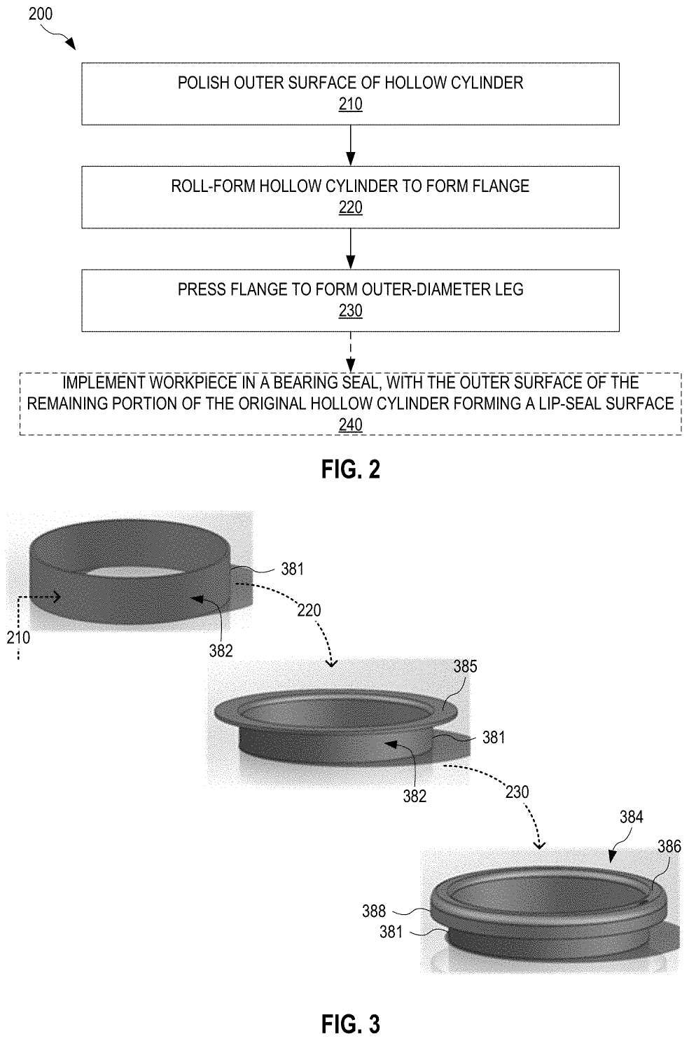

FIG. 2 is a flowchart for one method 200 for manufacturing a sleeve with a polished lip-seal surface. Method 200 may be used to produce sleeve 154 of bearing seal 150. FIG. 3 is a set of diagrams illustrating one example of method 200. FIGS. 2 and 3 are best viewed together in the following description. Method 200 includes steps 210, 220, and 230.

Step 210 polishes an outer surface of a hollow cylinder. In one example, step 210 polishes an outer surface 382 of a hollow cylinder 381. After polishing of the outer surface in step 210, step 220 roll-forms the hollow cylinder to form a flange extending radially outward from the remaining part of hollow cylinder 381. In one example, step 220 roll-forms hollow cylinder 381 to form a flange 385 extending radially outward from the remaining part of hollow cylinder 381. Step 230 presses the flange to form an outer-diameter leg. In one example, step 230 presses flange 385 to form, from flange 385, an outer-diameter leg 388 and a middle leg 386. Middle leg 386 is a remaining portion of flange 385. In this example, at the end of step 230, the resulting workpiece 384 has a shape similar to that of sleeve 154. Outer-diameter leg 388 may be parallel to the remaining part of hollow cylinder 381.

Method 200 may further include a step 240 of implementing the workpiece in a bearing seal, with the outer surface of the remaining part of the hollow cylinder forming a lip-seal surface. In one example, step 240 implements workpiece 384 in bearing seal 150, of drive wheel end 100, as sleeve 154, with the radially outward-facing surface of the remaining part of hollow cylinder 381 forming lip-seal surface 158.

Without departing from the scope hereof, step 210 may polish only part of the outer surface of the hollow cylinder. For example, referring to the example of FIG. 3, step 210 may polish only the part of outer surface 382 that is not bent to flange 385 in step 220, or step 210 may polish only the part of outer surface 382 that will be contacted by a lip when workpiece 384 is implemented in a bearing seal.

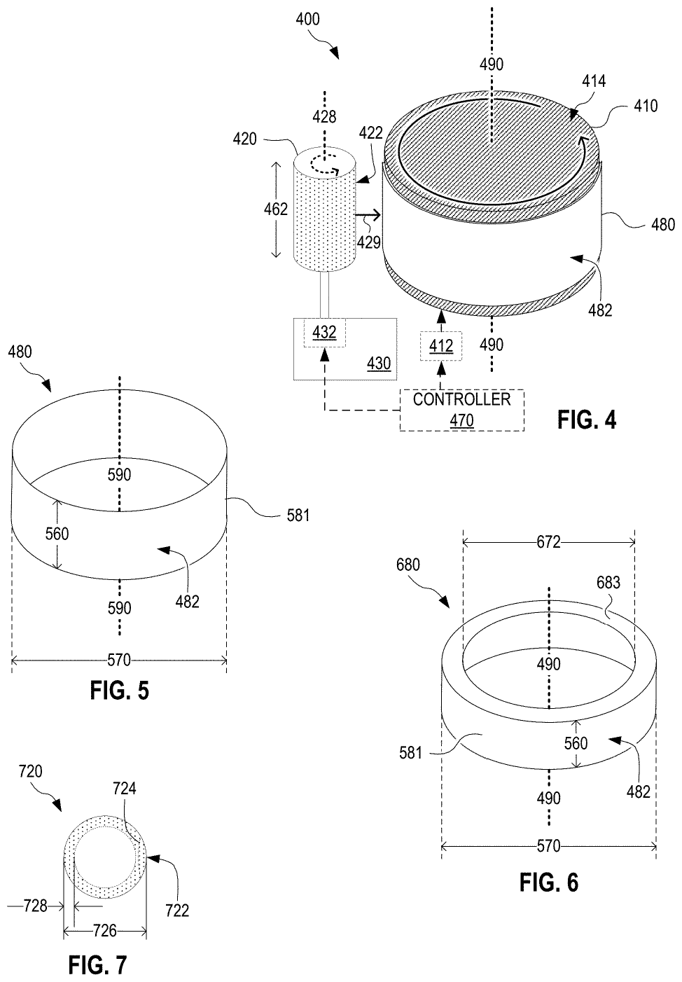

FIG. 4 illustrates one system 400 for polishing a cylindrical lip-seal surface. System 400 may perform step 210 of method 200. System 400 is configured to process a workpiece 480. FIG. 5 shows workpiece 480 in further detail. FIGS. 4 and 5 are best viewed together in the following description. Workpiece 480 includes a hollow cylinder 581 that has a cylinder axis 590. Hollow cylinder 581 has a cylindrical surface 482 that faces away from cylinder axis 590. In the example shown in FIG. 4, workpiece 480 is hollow cylinder 581. Without departing from the scope hereof, workpiece 480 may include other features, for example as discussed below in reference to FIG. 6.

System 400 includes a spin platter 410, a polisher 420, and a fixture 430. Spin platter 410 is configured to rotate about a rotation axis 490. When workpiece 480 is mounted on spin platter 410, spin platter 410 spins workpiece 480 about rotation axis 490. At least when workpiece 480 is fit tight onto spin platter 410, cylinder axis 590 coincides with rotation axis 490. In situations where there is some play between spin platter 410 and workpiece 480, spin platter 410 may spin workpiece 480 about an axis that is slightly offset from cylinder axis 590, which is equivalent to spinning workpiece 480 about its cylinder axis 590 while cylinder axis 590 undergoes a small-orbit motion about rotation axis 490. Polisher 420 includes an abrasive surface 422. Fixture 430 is configured to hold polisher 420 against cylindrical surface 482 to polish cylindrical surface 482 with abrasive surface 422 when workpiece 480 is being spun by spin platter 410. In one embodiment, fixture 430 is configured to translate polisher 420 along direction 429 to press polisher 420 against cylindrical surface 482.

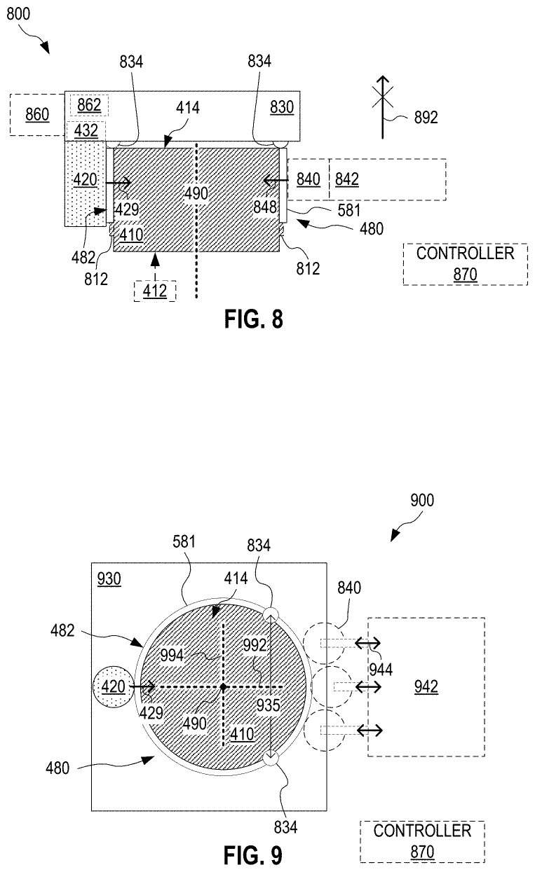

Cylindrical surface 482 has diameter 570. In an embodiment, diameter 570 is between 4 and 10 inches. In one example, diameter 570 is upwards limited at 10 inches by hardware holding spin platter 410 and downwards limited at 4 inches by the engagement length of one or more clamp rollers (e.g., clamp roller(s) 840 of FIG. 8 discussed below) configured to help hold workpiece 480 on spin platter 410. Cylindrical surface 482 has height 560 which, in an embodiment, is 2.5 inches or less. Polishing surface 422 has height 462. In one example, height 462 is at least as large as height 560, such the polisher 420 is capable of polishing all of cylindrical surface 482. In another embodiment, height 462 is less than height 560, such that polisher 420 polishes a height range of cylindrical surface 482 that is less than the full height range of cylindrical surface 482.

FIG. 6 shows another workpiece 680 that may be polished by system 400. Workpiece 680 is an embodiment of workpiece 480 that, in addition to hollow cylinder 581, includes a radially inward-facing lip 683. Lip 683 forms an aperture of diameter 672. Diameter 672 is less than diameter 570. System 400 may be oriented such that rotation axis 490 is vertical and system 400 is configured to accept workpiece 480 onto spin platter 410 from above spin platter 410. In this scenario, when workpiece 680 is mounted on spin platter 410, lip 683 may rest on a surface 414 of spin platter 410 and thus help secure workpiece 680 on spin platter 410.

Referring again to FIG. 4, spin platter 410 may have a flange (see, for example, flange 812 of FIG. 8) for supporting a bottom edge of embodiments of workpiece 480 that do not include lip 683.

FIG. 7 illustrates one cylindrical polishing wheel 720 in cross-sectional view, wherein the cross section is orthogonal to the axis of cylindrical polishing wheel 720. Cylindrical polishing wheel 720 is an embodiment of polisher 420 configured to rotate during polishing of cylindrical surface 482 in system 400. Cylindrical polishing wheel 720 has a cylindrical polishing surface 722 which is an embodiment of abrasive surface 422. Cylindrical polishing wheel 720 is formed, at least in part, by an abrasive material. In one embodiment, at least an outer cylindrical layer of non-zero thickness 728 is composed of an abrasive material, such that cylindrical polishing wheel 720 maintains it polishing capability over at least some use and associated wear of the abrasive material. In one example, thickness 728 is at least 1/16 of an inch, such as between 2/16 and 4/16 of an inch. The abrasive material of cylindrical polishing wheel 720 may be Scotch Brite, for example of 2A fine, 2A medium, or 2A course grade. The diameter 726 of cylindrical polishing wheel 720 is, for example, 8 inches or less. The diameter 726 may be upwards limited by other hardware of system 400. The height of cylindrical polishing surface 722 (an example of height 462) may be between 0.1 and 2.5 inches. The height of cylindrical polishing surface 722 may be downwards limited by hardware of fixture 430 and upwards limited by other hardware of system 400.

Referring now to FIGS. 4 and 7 in combination, in embodiments of system 400 implementing cylindrical polishing wheel 720, fixture 430 may include a motor 432 configured to spin cylindrical polishing wheel 720 about a rotation axis 428 that is parallel to rotation axis 490. Rotation of cylindrical polishing wheel 720 helps ensure even wear of the cylindrical polishing wheel, such that abrasive surface remains cylindrical. In embodiments where polisher 420 does not rotate, wear of polisher 420 may result in abrasive surface 422 gradually developing a concave shape on the side of polisher 420 that faces spin platter 410, for example as indicated by dashed line 724 in FIG. 7. In one implementation, the rotation direction of cylindrical polishing wheel 720 about rotation axis 428 is the same as the rotation direction of spin platter 410 about rotation axis 490, such that the rotation of cylindrical polishing wheel 720 speeds up polishing of workpiece 480.

In one embodiment of system 400 implementing cylindrical polishing wheel 720 and motor 432, system 400 further includes a controller 470 that controls motor 432. System 400 may also include a motor 412 configured to spin spin platter 410, and controller 470 may be configured to also control motor 412. Controller 470 is, for example, a computer, optionally coupled with external electronic circuitry.

FIG. 8 illustrates one system 800, for polishing cylindrical surface 482 of workpiece 480, which implements a fixture with at least one ball-transfer unit configured to help secure workpiece 480 on spin platter 410. System 800 is an embodiment of system 400, wherein fixture 430 is implemented as a fixture 830 that includes at least one ball-transfer unit 834. FIG. 8 depicts system 800 in a cross-sectional view, wherein the cross section is in a plane that includes rotation axis 490. Each ball-transfer unit 834 is configured to, when workpiece 480 is mounted on spin platter 410, limit movement of workpiece 480 in a direction 892 along rotation axis 490. During polishing of workpiece 480, fixture 830 (or at least a portion thereof) is positioned on a side of spin platter 410 from which workpiece 480 is mounted onto spin platter 410. In one scenario, system 800 is oriented such that cylinder axis 590 of workpiece 480 is vertical when workpiece 480 is mounted on spin platter 410, and system 800 is configured to accept workpiece 480 onto spin platter 410 from above spin platter 410. For example, system 800 may include motor 412 with motor 412 being positioned below spin platter 410. In this scenario, fixture 830 is positioned above spin platter 410 during polishing.

Each ball-transfer unit 834 helps prevent workpiece 480 from lifting off spin platter 410 when workpiece 480 is being polished by polisher 420. In the absence of ball-transfer unit(s) 834, the force exerted by polisher 420 may cause workpiece 480 to shift in direction 892 and thereby fully or partly remove workpiece 480 from polisher 420. In one scenario, the one or more ball-transfer units 834 are in constant contact with workpiece 480 throughout polishing. In another scenario, workpiece 480 can move on spin platter 410, in directions parallel to rotation axis 490, within a finite range, and the one or more ball-transfer units 834 limit this range. In either one of these scenarios, each ball-transfer unit 834 helps stabilize the position of workpiece 480 relative to spin platter 410 while imposing little or no friction on the spinning movement of workpiece 480.

In certain embodiments, system 800 includes one or more actuators 860 cooperatively configured to move fixture 830 between (a) an active-polishing position where polisher 420 presses on hollow cylinder 581 along direction 429 and (b) a pre-polishing position where polisher 420 is translated away from workpiece 480 in a direction opposite direction 429. Thus, in one embodiment, actuator(s) 860 include a translation stage configured to translate polisher 420, optionally together with all or some of fixture 830, in direction 429 and the direction opposite thereto. Actuator(s) 860 may further be configured to move fixture 830 between the pre-polishing position and a rest position where fixture 830 and polisher 420 are out of the way to allow mounting of workpiece 480 on spin platter 410 by lowering workpiece 480 onto spin platter 410 from above surface 414.

Fixture 830 may include a sensor 862 configured to sense proximity of polisher 420 to hollow cylinder 581 and/or pressure applied by polisher 420 onto hollow cylinder 581. Sensor 862 may serve to accurately place polisher 420 relative to workpiece 480 during polishing thereof, especially in the presence of wear of polisher 420. In one scenario, a series of workpieces 480 are polished by system 800 and the wear of polisher 420 requires adjustment of its active-polishing position between some of workpieces 480 of the series. In another scenario, the wear of polisher 420 is sufficiently rapid that adjustment of its active-polishing position is required during polishing of a single workpiece 480. Actuator(s) 860 may be capable of adjusting the active-polishing position of polisher 420.

In an embodiment, system 800 includes one or more clamp rollers 840 each configured to apply pressure on workpiece 480 along a direction 848. For each clamp roller 840, direction 848 is either opposite direction 429 or has a component that is opposite direction 429. Each clamp roller 840 may be coupled with an actuator 842 configured to move clamp roller 840 toward spin platter 410 along direction 848. In embodiments of system 800 that include a plurality of clamp rollers 840, two or more of clamp rollers 840 may share the same actuator 842.

System 800 may include a controller 870 configured to control one or more of motor 412, motor 432, actuator(s) 842, and actuator(s) 860. Controller 870 may receive input from sensor 862. For clarity of illustration, communication links to and from controller 870 are omitted from FIG. 8.

In an alternative embodiment that is not illustrated in FIG. 8, system 800 includes the one or more clamp rollers 840 but does not include any ball-transfer units 834.

FIG. 8 further illustrates an optional flange 812 that spin platter 410 may include in either one of systems 400 and 800. Flange 812 forms a support for embodiment of workpiece 480 that do not include lip 683. In one embodiment, flange 812 is a continuous flange forming a full circle. In another embodiment, flange 812 is interrupted by gaps.

FIG. 9 illustrates one system 900, for polishing cylindrical surface 482 of workpiece 480, which implements a fixture with two ball-transfer units configured to help secure workpiece 480 on spin platter 410. System 900 is an embodiment of system 800, wherein fixture 830 is implemented as a fixture 930 that includes two ball-transfer units 834. FIG. 9 depicts system 900 as viewed from above surface 414 of spin platter, together with an outline of fixture 930 and example positions of ball-transfer units 834. In system 900, ball-transfer units 834 are distributed about rotation axis 490 to limit pivoting of workpiece 480 about axes that have a component parallel to direction 429. FIG. 9 shows orthogonal axes 992 and 994 in the plane of rotation of spin platter 410. In one example, ball-transfer units 834 are disposed on opposite sides of axis 992, and both ball transfer units 834 are on a side of axis 994 that is opposite polisher 420. To best prevent pivoting of workpiece 480 about axis 992, the distance 935 between ball transfer units 834 along axis 994 may be at least 80 percent of the diameter of workpiece 480, and thus also at least 80% of the diameter of spin platter 410.

System 900 may further include three clamp rollers 840 and an associated actuation module 942 configured to translate each clamp roller 840 along a direction 944 that is parallel to direction 429. Actuation module 942 is an embodiment of actuator(s) 842. A central one of the three clamp rollers 840 is directly opposite polisher 420. Actuation module 942 may use a single actuator to translate all three clamp rollers 840. Alternatively, one or all of clamp rollers 840 may be coupled to a separate actuator in actuation module 942. In one example, the central clamp roller 840 is hydraulically actuated and the flanking clamp rollers 840 are pneumatically actuated.

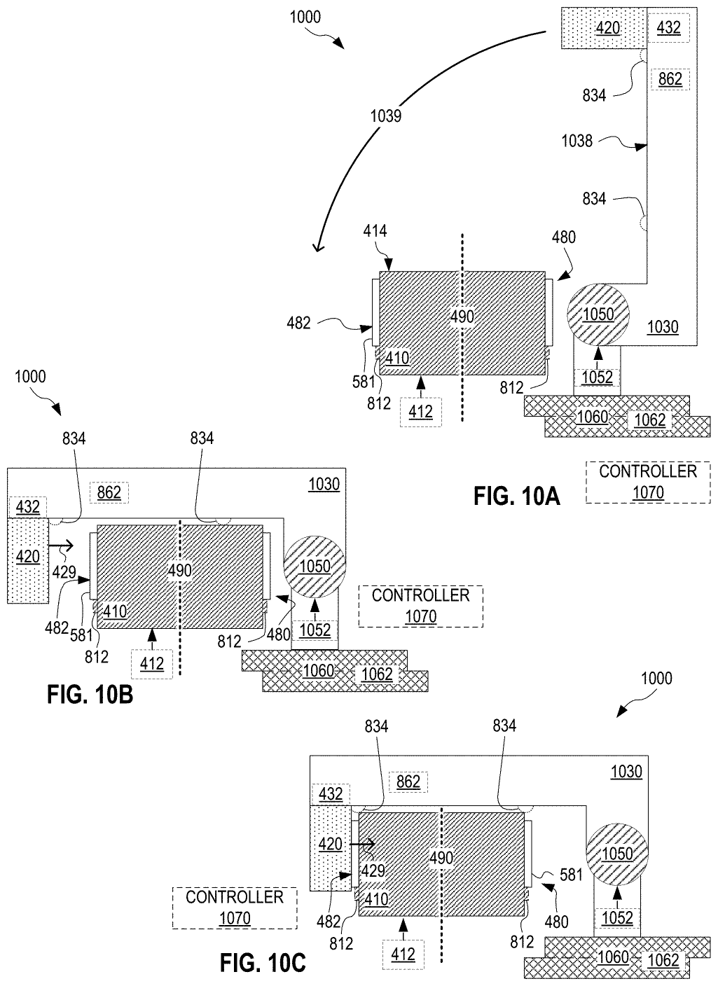

FIGS. 10A-C illustrate one system 1000 for polishing cylindrical surface 482 of workpiece 480, wherein polisher 420 is mounted on a translatable swing arm 1030 configured to swing out of the way to provide access to spin platter 410. System 1000 is an embodiment of system 400 that includes swing arm 1030 and a translation stage 1060. FIGS. 10A, 10B, and 10C show system 1000 with polisher 420 in a rest position, a pre-polishing position, and an active-polishing position, respectively. FIGS. 10A-C are best viewed together in the following description. Swing arm 1030 is coupled to translation stage 1060 via a pivot joint 1050. The pivot axis of pivot joint 1050 is orthogonal to both rotation axis 490 and direction 429 (shown in FIG. 10B). Translation stage 1060 is configured to translate in direction 429 and the direction opposite thereto.

When polisher 420 is in its rest position (shown in FIG. 10A), swing arm 1030 and polisher 420 are positioned to allow access to spin platter 410 from the side associated with surface 414. This allows for mounting of workpiece 480 on spin platter 410 by lowering workpiece 480 onto spin platter 410 from about surface 414, and also allows removal of workpiece 480 from spin platter 410 by the opposite process. In the pre-polishing position (shown in FIG. 10B), polisher 420 has an axial position (with respect to rotation axis 490) coincides with the axial position of spin platter 410, but polisher 420 is offset from rotation axis 490 in the direction opposite direction 429 such that polisher 420 is radially outside an outside diameter of spin platter 410 by a non-zero amount. In the pre-polishing position, polisher 420 is outside the outside diameter of spin platter 410 by an amount that, when workpiece 480 is mounted on spin platter 410, is sufficient to avoid contact between polisher 420 and workpiece 480. In the active-polishing position (shown in FIG. 10C), polisher 420 is held against cylindrical surface 482 such that, when spin platter 410 spins workpiece 480, polisher 420 polishes cylindrical surface 482.

In operation, after mounting workpiece 480 of spin platter 410, swing arm 1030 is pivoted, at pivot joint 1050, from its rest position (FIG. 10A) to its pre-polishing position (FIG. 10B), as indicated by arrow 1039. Next, translation stage 1060 places polisher 420 in its active-polishing position (FIG. 10C). This entails translation stage 1060 translating swing arm 1030 and pivot joint 1050 along direction 429 to hold polisher 420 against cylindrical surface 482. In one scenario, spin platter 410 initiates its rotation prior to or during translation stage 1060 moving polisher 420 from its pre-polishing position to its active-polishing position. In another scenario, spin platter 410 initiates its rotation after that translation stage 1060 has moved polisher 420 from its pre-polishing position to its active-polishing position. After polishing of cylindrical surface 482, the steps indicated by FIGS. 10A-C may be reversed such that the polished workpiece 480 can be removed from system 1000. Without departing from the scope hereof, reconfiguring of system 1000 between the FIGS. 10A and 10B configurations may involve translation by translation stage 1060.

System 1000 may include one or both of actuators 1052 and 1062. Actuator 1052 is configured to actuate pivoting of swing arm 1030 about the pivot axis of pivot joint 1050. Actuator 1062 is configured to actuate translation of translation stage 1060.

System 1000 may also include one or more of (a) one or more ball-transfer units 834, as discussed above in reference to FIGS. 8 and 9, coupled to swing arm 1030, (b) sensor 862, (c) flange 812, (d) one or more clamp rollers 840 as discussed above in reference to FIGS. 8 and 9 (for clarity of illustration, not shown in FIGS. 10A-C). Thus, system 1000 may form an embodiment of either one or systems 800 and 900. In embodiments of system 1000 that include one or more ball-transfer units 834, each ball-transfer unit 834 is mounted to swing arm 1030 on a side 1038 of swing arm 1030 that faces surface 414 of spin platter 410 when swing arm 1030 is oriented to hold polisher 420 in its pre-polishing position or active-polishing position. Embodiments of system 1000 that include one or more clamp rollers 840 may further include actuator(s) 842 or actuator module 942.

System 1000 may further include a controller 1070, an embodiment of controller 470. Controller 1070 may control one or more of motor 412, motor 432, actuator 1052, actuator(s) 842, and actuator module 942. Controller 1070 may receive input from sensor 862 to accurately position polisher 420 in its active-polishing position.

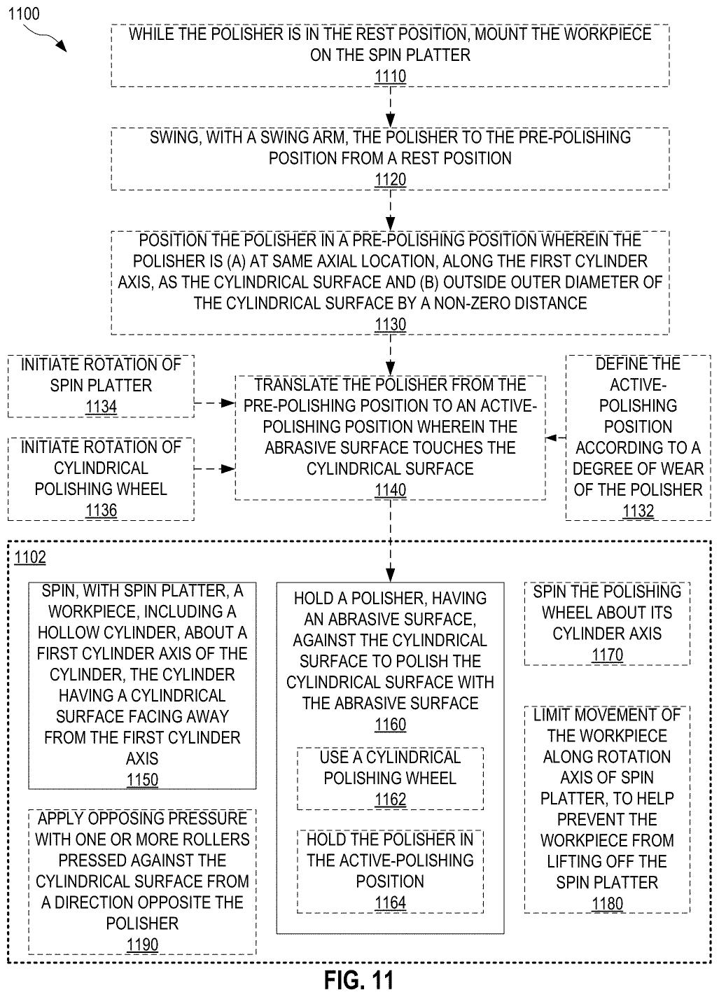

FIG. 11 illustrates one method 1100 for polishing a cylindrical lip-seal surface. Method 1100 may be implemented in method 200 as step 210. Method 1100 may be used to polish cylindrical surface 482 of workpiece 480, and method 1100 may utilize system 400. Method 1100 includes a group 1102 of steps that are performed simultaneously. Group 1102 includes steps 1150 and 1160. Step 1150 spins, with a spin platter, a workpiece that includes a hollow cylinder. Step 1150 spins the workpiece about the cylinder axis of the hollow cylinder. The cylinder has a cylindrical surface facing away from the cylinder axis of the hollow cylinder. During step 1150, step 1160 holds a polisher, having an abrasive surface, against the cylindrical surface to polish the cylindrical surface with the abrasive surface. In one example of steps 1150 and 1160, spin platter 410 spins workpiece 480 (in step 1150), and fixture 430 holds polisher 420 against cylindrical surface 482 of workpiece 480 (in step 1160).

In an embodiment, step 1160 implements a step 1162 of using a cylindrical polishing wheel, such as cylindrical polishing wheel 720, and group 1102 further includes a step 1170 of spinning the cylindrical polishing wheel about its cylinder axis, for example as discussed above in reference to FIGS. 4 and 7.

In an embodiment, group 1102 further includes one or both of steps 1180 and 1190. Step 1180 limits movement of the workpiece along the rotation axis of the spin platter, to help prevent the workpiece from lifting off the spin platter. In one example of step 1180, one or more ball-transfer units 834 limit movement of workpiece 480 along rotation axis 490, as discussed above in reference to FIGS. 8, 9, and 10A-C. Step 1190 applies pressure, opposing the pressure applied by the polisher, with one or more clamp rollers pressed against the cylindrical surface from a direction generally opposite the polisher. In one example of step 1190, one or more clamp rollers 840 apply pressure on cylindrical surface 482 from a direction generally opposite that of polisher 420, as discussed above in reference to FIGS. 8 and 9.

In certain embodiments of method 1100, group 1102 is preceded by steps 1130 and 1140, and step 1160 implements a step 1164. Step 1130 positions the polisher in a pre-polishing position wherein the polisher is (a) at same axial location, along the cylinder axis of the workpiece, as the cylindrical surface and (b) outside the outer diameter of the cylindrical surface by a non-zero distance. After step 1130, step 1140 translates the polisher from the pre-polishing position to an active-polishing position wherein the abrasive surface of the polisher touches the cylindrical surface, such that step 1160 implements a step 1164 of holding the polisher in the active-polishing position. In one example of steps 1130, 1140, and 1162, fixture 430 or fixture 839 positions polisher 420 in the pre-polishing position in step 1130, then translates polisher 420 along direction 429 to position polisher 420 in the active-polishing position in step 1140, and keeps (in step 1164) polisher 420 in the active-polishing position during polishing. In another example of steps 1130 and 1140, swing arm 1030 of system 1000 swings polisher 420 into its pre-polishing position in step 1130, whereafter translation stage 1060 translates polisher 420 to its active-polishing position in step 1140 and keeps (in step 1164) it there during polishing, as discussed above in reference to FIGS. 10A-C.

In certain embodiments of method 1100 that include steps 1130, 1140, and 1164, step 1140 is preceded by a step 1134 of initiating rotation of the spin platter. In one example of step 1134, rotation of spin platter 410 about rotation axis 490 is initiated before polisher 420 is translated from the pre-polishing position to the active-polishing position (or at least before polisher 420 contacts workpiece 480), such that workpiece 480 is spinning before polisher 420 contacts workpiece 480. Similarly, in embodiments of method 1100 that include steps 1130, 1140, and 1164, and further implement step 1162, step 1140 may be preceded by a step 1136 of initiating rotation of the cylindrical polishing wheel. In one example of step 1136, rotation of cylindrical polishing wheel 720 is initiated before cylindrical polishing wheel 720 is translated from the pre-polishing position to the active-polishing position (or at least before cylindrical polishing wheel 720 contacts workpiece 480), such that cylindrical polishing wheel 720 is rotating before making contact with workpiece 480. In one embodiment, method 1100 includes both step 1134 and step 1136.

In one embodiment of method 1100 that includes steps 1130, 1140, and 1164, step 1130 is preceded by steps 1110 and 1120. Step 1120 uses a swing arm to swing the polisher to the pre-polishing position from a rest position. In one example of step 1120, swing arm 1030 swings polisher from its rest position (FIG. 10A) to its pre-polishing position (FIG. 10B), as discussed above in reference to FIGS. 10A-C. Before step 1120, while the polisher is in its rest position, step 1110 mounts the workpiece on the spin platter, for example as discussed above in reference to FIG. 10A.

Method 1100 may further include a step 1132 of defining the active-polishing position according to a degree of wear of the polisher. In one implementation of step 1132, the active-polishing position of polisher 420 is adjusted periodically or gradually, according to a pre-determined rate of wear of polisher 420. For example, controller 470 (e.g., controller 1070) may be preprogrammed, according to pre-determined rate of wear, to periodically or gradually correct the active-polishing position of polisher 420 (e.g., via translation stage 1060). In another implementation of step 1132, the active-polishing position of polisher 420 is adjusted periodically or gradually, according to a measurement of (a) proximity of polisher 420 to workpiece 480 or (b) pressure exerted by polisher 420 onto workpiece 480. For example, controller 1070 may receive such a measurement from sensor 862 and adjust translation stage 1060 accordingly.

Although not shown in FIG. 11, step 1140 may include sensing when the polisher has reached the active-polishing position. In one example of step 1140, sensor 862 senses when polisher 420 has reached the active-polishing position and communicates this measurement to controller 1070.

Method 1100 may be adapted to adjust the relative speed between the polisher and the workpiece to start out with relatively aggressive polishing of the lip-seal surface and finish with finer polishing. In one such embodiment, step 1150 includes increasing the rate of rotation of the spin platter to transition from an initial, relatively aggressive polishing of the lip-seal surface, to a subsequent, finer polishing of the lip-seal surface. In another embodiment, method 1100 includes steps 1162 and 1170, and step 1170 includes increasing the rate of rotation of the cylindrical polishing wheel to transition from an initial, relatively aggressive polishing of the lip-seal surface, to a final, finer polishing of the lip-seal surface. This embodiment may be combined with step 1150 increasing the rotation rate of the spin platter.

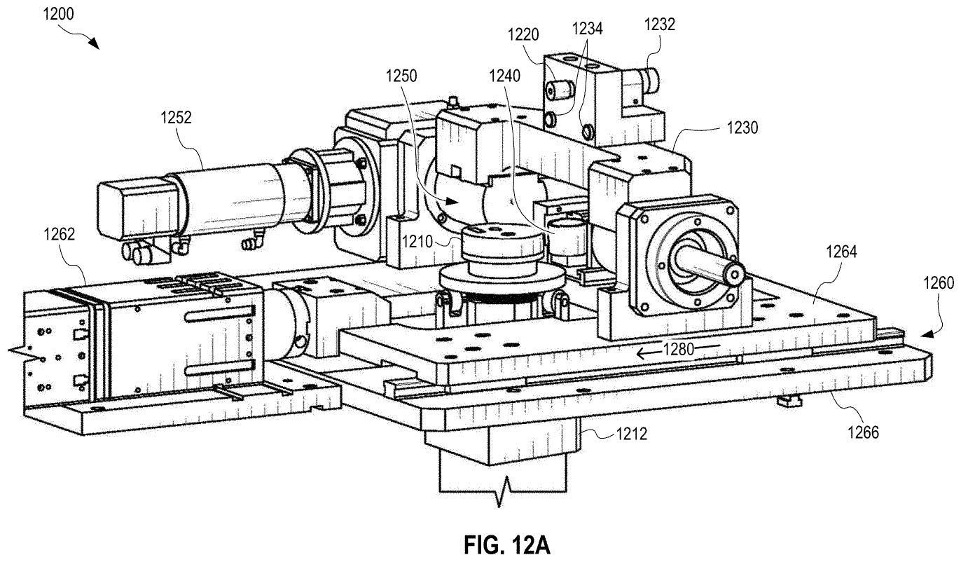

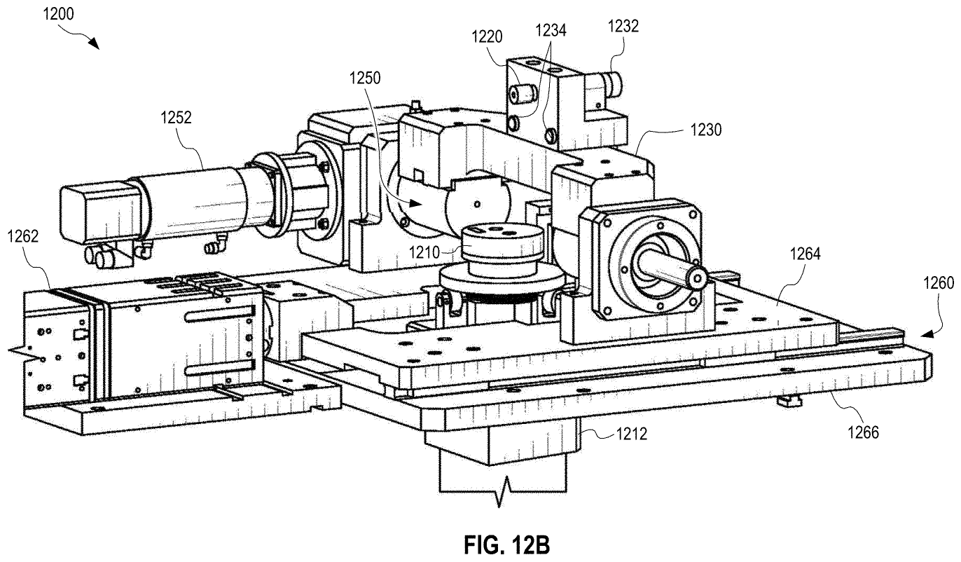

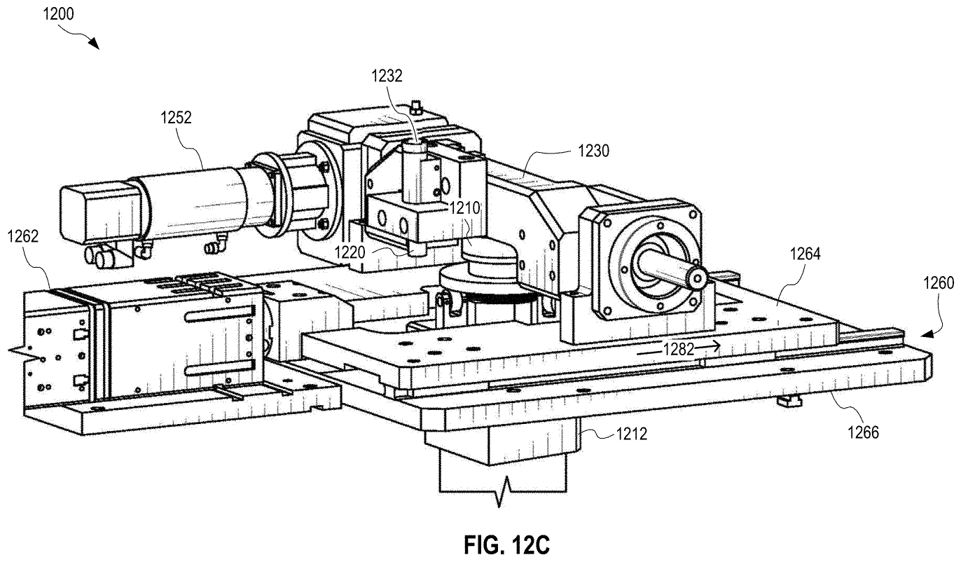

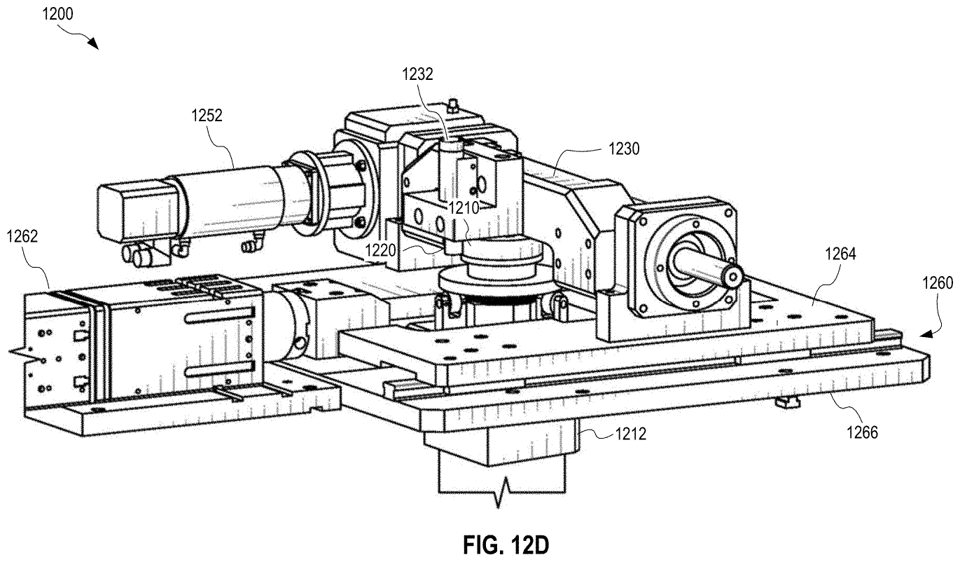

FIGS. 12A-D illustrate, in perspective view, one system 1200 for polishing cylindrical surface 482 of workpiece 480. System 1200 is an embodiment of system 1000 and also an embodiment of system 800. System 1200 may perform method 1100. System 1200 includes a spin platter 1210, a motor 1212 configured to rotate spin platter 1210, a translation stage 1260 having a stationary part 1266 and a moveable part 1264, a linear actuator 1262 configured to actuate movement of moveable part 1264 relative to stationary part 1266, a swing arm 1230 coupled to moveable part 1264 via a pivot joint 1250, an actuator 1252 configured to actuate pivoting of swing arm 1230 about pivot joint 1250, a cylindrical polishing wheel 1220 mounted on swing arm 1230, a motor 1232 configured to rotate cylindrical polishing wheel 1220, at least two ball-transfer units 1234 mounted on swing arm 1230, at least one clamp roller 1240, and (hidden from view) at least one actuator for the at least one clamp roller 1240. System 1200 may further include a controller that, during operation, controls each of motor 1212, motor 1232, linear actuator 1262, actuator 1252, and the at least one actuator for clamp roller(s) 1240. FIGS. 12A-D show different configurations of system 1200 used in the process to polish workpiece 480. FIGS. 12A-D are best viewed together in the following description.

FIG. 12A shows system 1200 when configured to hold cylindrical polishing wheel 1220 in a first rest position to provide access to spin platter 1210, so as to allow mounting of workpiece 480 (not shown in FIGS. 12A-D) on spin platter 1210 and removal of workpiece 480 from spin platter 1210. FIG. 12B shows system 1200 when configured to hold cylindrical polishing wheel 1220 in a second rest position. FIG. 12C shows system 1200 when configured to hold cylindrical polishing wheel 1220 in a pre-polishing position, ready to move cylindrical polishing wheel 1220 to the active-polishing position shown in FIG. 12D.

In operation, for example when performing method 1100, workpiece 480 is mounted on spin platter 1210 while system 1200 is configured as shown in FIG. 12A. Next, linear actuator 1262 translates moveable part 1264 in a direction 1280 (indicated in FIG. 12A) to reach the configuration shown in FIG. 12B. From the FIG. 12B configuration, actuator 1252 pivots swing arm 1230 down over spin platter 1210 to position cylindrical polishing wheel 1220 in its pre-polishing configuration shown in FIG. 12C. Linear actuator 1262 then translates moveable part 1264 in a direction 1282 to position cylindrical polishing wheel 1220 in its active-polishing position shown in FIG. 12D, and also align ball-transfer units 1234 with workpiece 480. While cylindrical polishing wheel 1220 is in its active-polishing position, motors 412 and 432 run simultaneously to polish a cylindrical surface 482 or workpiece 480. After completion of polishing of cylindrical surface 482, the FIGS. 12A-D progression is reversed and workpiece 480 is removed from spin platter 1210.

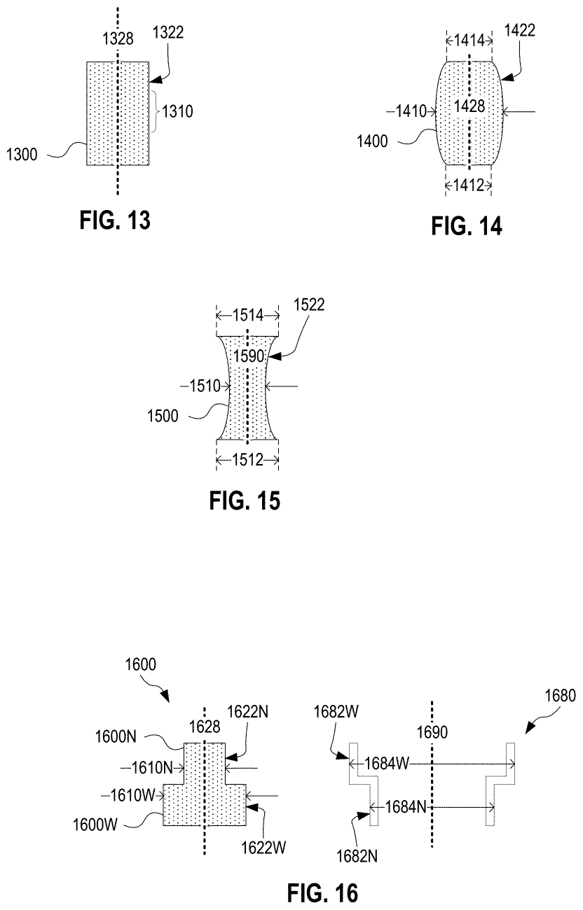

FIG. 13 illustrates one polisher 1300 having non-uniform surface roughness. Polisher 1300 is an embodiment of polisher 420 and may be implemented in any one of systems 400, 800, 900, 1000, and 1200. Polisher 1300 has a polishing surface 1322 and a longitudinal axis 1328. When implemented in system 400, 800, 900, 1000, or 1200, longitudinal axis 1328 is parallel to rotation axis 490 during polishing. The roughness (e.g., grit) of surface 1322 is non-uniform in the dimension parallel to longitudinal axis 1328, so as to tune how much polishing is done by polisher 1300 along longitudinal axis 1328. For example, a range 1310 of polishing surface 1322 may have a different surface roughness than the rest of polishing surface 1322. In one embodiment, polisher 1300 is configured as a cylindrical polishing wheel, such that polishing surface 1322 is cylindrical. This cylindrical polishing wheel is an example of cylindrical polishing wheel 720, wherein longitudinal axis 1328 coincides with rotation axis 428.

FIG. 14 illustrates one convex polisher 1400. Polisher 1400 is an embodiment of polisher 420 and may be implemented in any one of systems 400, 800, 900, 1000, and 1200. Polisher 1400 has a longitudinal axis 1428. When implemented in system 400, 800, 900, 1000, or 1200, longitudinal axis 1428 is parallel to rotation axis 490 during polishing. Polisher 1400 has a convex polishing surface 1422 characterized by a maximum diameter 1410, a bottom diameter 1412, and a top diameter 1414. Maximum diameter 1410 exceeds each of bottom diameter 1412 and top diameter 1414. Bottom diameter 1412 and top diameter 1414 may be identical. By virtue of convex polishing surface 1422, polisher 1400 polishes more aggressively near its center than at its ends. Polisher 1400 may thus be used to polish cylindrical surface 482 in such a manner as to primarily polish a central portion of cylindrical surface 482 and less so (if at all) the top and bottom portions of cylindrical surface 482. In one embodiment, polisher 1400 is configured as a polishing wheel similar to cylindrical polishing wheel 720 apart from being convex instead of cylindrical, wherein longitudinal axis 1428 coincides with rotation axis 428.

FIG. 15 illustrates one concave polisher 1500. Polisher 1500 is an embodiment of polisher 420 and may be implemented in any one of systems 400, 800, 900, 1000, and 1200. Polisher 1500 has a longitudinal axis 1528. When implemented in system 400, 800, 900, 1000, or 1200, longitudinal axis 1528 is parallel to rotation axis 490 during polishing. Polisher 1500 has a concave polishing surface 1522 characterized by a minimum diameter 1510, a bottom diameter 1512, and a top diameter 1514. Minimum diameter 1510 is less than each of bottom diameter 1512 and top diameter 1514. Bottom diameter 1512 and top diameter 1514 may be identical. By virtue of concave polishing surface 1522, polisher 1500 polishes more aggressively near its ends than at its center. Polisher 1500 may thus be used to polish cylindrical surface 482 in such a manner as to primarily polish top and bottom portions of cylindrical surface 482 and less so (if at all) a central portion of cylindrical surface 482. In one embodiment, polisher 1500 is configured as a polishing wheel similar to cylindrical polishing wheel 720 apart from being concave instead of cylindrical, wherein longitudinal axis 1528 coincides with rotation axis 428.

FIG. 16 illustrates one stepped-diameter polisher 1600 in an example use scenario. Polisher 1600 is an embodiment of polisher 420 and may be implemented in any one of systems 400, 800, 900, 1000, and 1200. Polisher 1600 has a longitudinal axis 1628. When implemented in system 400, 800, 900, 1000, or 1200, longitudinal axis 1628 is parallel to rotation axis 490 during polishing. Polisher 1600 has a wider portion 1600W with a polishing surface 1622W characterized by a diameter 1610W, and a narrower portion 1600N with a surface 1622N characterized by a diameter 1610N. Diameter 1610N is less than diameter 1610W. In the use scenario depicted in FIG. 16, polisher 1600 is used to polish a workpiece 1680 having a stepped diameter. Workpiece has a narrower cylindrical surface 1682N characterized by a diameter 1684N, and a wider cylindrical surface 1682W characterized by a diameter 1684W. Polishing surface 1622W is configured to polish narrower cylindrical surface 1682N. Surface 1622N may be abrasive as well, and be configured to simultaneously polish wider cylindrical surface 1682W. Alternatively, diameter 1610N may be sized to avoid contact between surface 1622N and workpiece 1680. In one embodiment, polisher 1600 is configured as a polishing wheel similar to cylindrical polishing wheel 720 apart from having a stepped diameter, wherein longitudinal axis 1628 coincides with rotation axis 428.

Changes may be made in the above systems and methods without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present systems and methods, which, as a matter of language, might be said to fall therebetween.

What is claimed is:

1. A system for polishing a cylindrical lip-seal surface, comprising:
a spin platter configured to rotate about a rotation axis to spin a workpiece, shaped as a hollow cylinder, about a cylinder axis of the hollow cylinder, the hollow cylinder having a cylindrical surface facing away from the cylinder axis;
a polisher with an abrasive surface; and
a fixture configured to hold the polisher against the cylindrical surface to polish the cylindrical surface with the abrasive surface while the workpiece is spun by the spin platter.

2. The system of claim 1, wherein:
the polisher comprises a cylindrical polishing wheel; and
the fixture comprises a motor configured to spin the polishing wheel about a second rotation axis that is parallel to the rotation axis of the spin platter.

3. The system of claim 2, wherein the polishing wheel:
is convex;
has a first end and a second end at opposite extremes along the second rotation axis; and
has a maximum diameter, about the second rotation axis, that exceeds a diameter of the polishing wheel at the first end and a diameter of the polishing wheel at the second end.

4. The system of claim 2, wherein the polishing wheel:
is concave;
has a first end and a second end at opposite extremes along the second rotation axis; and
has a minimum diameter, about the second rotation axis, that is less than a diameter of the polishing wheel at the first end and a diameter of the polishing wheel at the second end.

5. The system of claim 2, wherein:
the polishing wheel comprises first and second cylindrical portions that share a common cylinder axis that coincides with the second rotation axis;
a diameter of the first cylindrical portion exceeds a diameter of the second cylindrical portion; and
at least the first cylindrical portion is abrasive.

6. The system of claim 1, wherein:
the polisher has a longitudinal axis that is parallel to the rotation axis when the fixture holds the polisher against the cylindrical surface to polish the cylindrical surface; and
the abrasive surface has non-uniform surface roughness in a dimension along the longitudinal axis.

7. The system of claim 1, the fixture comprising at least one ball transfer unit configured to, when the workpiece is mounted on the spin platter, limit movement of the workpiece in a direction along the rotation axis, to help prevent the workpiece from lifting off the spin platter when the workpiece is being polished by the polisher.

8. The system of claim 1, the fixture comprising:
a translation stage configured to translate the polisher toward the spin platter along a first direction that is perpendicular to, and toward, the rotation axis, to place the polisher against the cylindrical surface; and
at least one clamp roller mounted on the translation stage; and
at least one actuator configured to force, along a direction opposite the first direction, the at least one clamp roller toward the spin platter, and when the workpiece is mounted on the spin platter, against the cylindrical surface.

9. The system of claim 8, wherein:
the fixture further includes a swing arm coupled to the translation stage via a pivot joint having a pivot axis that is orthogonal to both the first direction and the rotation axis, the swing arm being coupled between the polisher and the translation stage; and
the translation stage and swing arm are cooperatively configured to facilitate positioning of the polisher in a pre-polishing position, wherein the polisher (i) has an axial location, in an axial dimension parallel to the rotation axis, that coincides with the spin platter and (ii) is offset from the rotation axis to be outside an outer diameter of the spin platter, the fixture further comprising at least one ball transfer unit mounted to the swing arm on a side of the swing arm that, when the polisher is in the pre-polishing position, faces the spin platter.

10. A method for polishing a cylindrical lip-seal surface, comprising:
spinning, with a spin platter, a workpiece shaped as a hollow cylinder about a first cylinder axis of the hollow cylinder, the hollow cylinder having a cylindrical surface facing away from the first cylinder axis; and
holding, during said spinning, a polisher having an abrasive surface against the cylindrical surface to polish the cylindrical surface.

11. The method of claim 10, wherein:
the polisher is a cylindrical polishing wheel having a second cylinder axis that, during said holding, is parallel to the first cylinder axis; and
the method further comprises spinning, during said holding, the cylindrical polishing wheel about the second cylinder axis.

12. The method of claim 11, further comprising increasing, during said spinning the cylindrical polishing wheel, a rotation rate of the cylindrical polishing wheel.

13. The method of claim 10, further comprising, prior to said holding the polisher against the cylindrical surface:
positioning the polisher in a pre-polishing position, the polisher being (i) at a same axial location, along the first cylinder axis, as the cylindrical surface and (ii) outside an outer diameter of the cylindrical surface by a non-zero distance; and
translating the polisher from the pre-polishing position to an active-polishing position, the abrasive surface touching the cylindrical surface such that said holding the polisher against the cylindrical surface includes holding the polisher in the active-polishing position.

14. The method of claim 13, further comprising defining the active-polishing position according to a degree of wear of the polisher.

15. The method of claim 13, wherein said translating further comprises sensing when the polisher has reached the active-polishing position.

16. The method of claim 13, further comprising:
swinging, with a swing arm and prior to said positioning the polisher in the pre-polishing position, the polisher to the pre-polishing position from a rest position; and
mounting, while the polisher is in the rest position, the workpiece on the spin platter.

17. The method of claim 13, further comprising increasing, during said holding, a rotation rate of the spin platter.

18. The method of claim 10, further comprising limiting, during said holding the polisher against the cylindrical surface, movement of the workpiece along a rotation axis of the spin platter by contacting the workpiece with at least one ball transfer unit to prevent the workpiece from lifting off the spin platter.

19. The method of claim 10, further comprising applying, during said holding the polisher against the cylindrical surface, opposing pressure with one or more rollers pressed against the cylindrical surface from a direction opposite the polisher.

20. The method of claim 10, further comprising:
roll-forming, after said spinning and said holding, the workpiece by bending a portion of the hollow cylinder radially outward to form a flange that (i) surrounds, and is orthogonal to, the first cylinder axis and (ii) connects to a remaining portion of the hollow cylinder;
pressing, after said roll-forming, the workpiece to fold over a radially-outermost portion of the flange to form a second cylinder that connects to a remaining portion of the hollow cylinder via a remaining portion of the flange and surrounds the remaining portion of the hollow cylinder; and
implementing, after said pressing, the workpiece in a bearing seal, the cylindrical surface of the remaining portion of the hollow cylinder being configured to form a lip-seal surface.
